(19) United States
(12) Patent Application Publication
(10) Pub. No.: US 2022/0297461 A1
(43) Pub. Date: Sep. 22, 2022

(54) SELF-CONTAINED STENCILING KIT FOR PRODUCING MULTICOLOR AND/OR UNICOLOR COMPOSITE IMAGES

(71) Applicant: INNOVATIVE ART CONCEPTS, LLC, Ramsey, NJ (US)

(72) Inventors: John G. SWISHER, Mahwah, NJ (US); Janna MAKAEVA, Mahwah, NJ (US)

(73) Assignee: INNOVATIVE ART CONCEPTS, LLC, Ramsey, NJ (US)

(21) Appl. No.: 17/699,051

(22) Filed: Mar. 18, 2022

Related U.S. Application Data
(60) Provisional application No. 63/163,773, filed on Mar. 19, 2021.

(51) Int. Cl. B41N 1/24; B44D 2/00

(52) U.S. Cl. CPC B41N 1/248; B44D 2/002

(57) ABSTRACT

The present disclosure relates to a self-contained stenciling kit for producing multicolor and/or unicolor composite images on a target surface, such as a piece of paper. The present disclosure also relates to a method of using the self-contained stenciling kit to produce a multicolor and/or unicolor composite image on a target surface.

### CROSS-REFERENCE TO RELATED APPLICATIONS

This application claims priority benefit of U.S. Provisional Patent Application Ser. No. 63/163,773, filed Mar. 19, 2021, the disclosure of which is hereby incorporated by reference herein in its entirety.

### FIELD OF THE INVENTION

The present invention relates to a self-contained stenciling kit for producing multicolor and/or unicolor composite images, as well as to methods of using the kit.

### BACKGROUND OF THE INVENTION

Stencil art is a good way for children and adults to engage in a rewarding creative activity. Stencil art can be enjoyed as a craft hobby, as well as for therapeutic and relaxation purposes. However, there often is a need to assemble all the tools and supplies needed to create a piece of stencil art, particularly if the desire is to prepare a multicolor composite image with different colors, or even a unicolor image, or using different stencil patterns to produce a single composite image, whether multicolor or unicolor or shades of the same or different colors. Therefore, there is a need for a more self-contained kit for producing this sort of stencil art.

The present invention is directed to overcoming these and other deficiencies in the art.

### SUMMARY OF THE INVENTION

The present disclosure relates to, inter alia, a self-contained stenciling kit for producing multicolor and/or unicolor composite images on a target surface. The present disclosure also relates to, inter alia, a method of using the self-contained stenciling kit to produce a multicolor and/or unicolor composite image on a target surface.

In one aspect, the present disclosure provides a self-contained stenciling kit for producing a multicolor and/or unicolor composite image on a target surface, said kit comprising: a foldable case comprising a front compartment, a rear compartment, and a hinged spine, said front compartment and rear compartment each being pivotally or flexibly mounted adjacent to said hinged spine; wherein said front compartment comprises an easel pivotally or flexibly mounted to the bottom of the front compartment and a first storage region behind the easel, wherein said easel comprises an alignment pocket and a clip, said alignment pocket being located along the bottom edge of the easel for holding and aligning the target surface and the stencil plate during operation, and said clip being attached at its top edge of the easel for securing the target surface and stencil plate in place during operation, wherein said rear compartment comprises a pen/pencil (marking device) holder pivotally or flexibly mounted to the bottom of the rear compartment and a second storage region behind the pen/pencil (marking device) holder, said second storage region suitable for storing multiple stencil plates.

In another aspect, the present disclosure provides a method of producing a multicolor and/or unicolor composite image on a target surface, said method comprising: (a) providing a self-contained stenciling kit according to any one of claims 1-6 and a collection of stencil plates; (b) securing a target surface and a stencil plate at a desired position on the easel using the clip and alignment pocket of the easel; (c) tracing, marking, and/or coloring the image of the stencil plate to the target surface; (d) removing the stencil plate from the easel; and (e) optionally repeating steps (b)-(d) for a desired number of stencil plates from the collection of stencil plates to produce the multicolor and/or unicolor composite image on the target surface.

### BRIEF DESCRIPTION OF THE DRAWINGS

For the purpose of illustrating aspects of the present invention, there are depicted in the drawings certain embodiments of the invention. However, the invention is not limited to the precise arrangements and instrumentalities of the embodiments depicted in the drawings. Further, as provided, like reference numerals contained in the drawings are meant to identify similar or identical elements.

The patent or application file contains at least one drawing executed in color. Copies of this patent or patent application publication with color drawings will be provided by the U.S. Patent and Trademark Office upon request and payment of the necessary fee.

FIG. 1 is an illustration of a closed front view of one embodiment of a self-contained stenciling kit of the present disclosure.

FIG. 2 is an illustration of a closed perspective front view of one embodiment of a self-contained stenciling kit of the present disclosure.

FIG. 3 is an illustration of a snap closure portion of one embodiment of a self-contained stenciling kit of the present disclosure.

FIG. 4 is an illustration of a hinged side portion of one embodiment of a self-contained stenciling kit of the present disclosure.

FIG. 5 is an illustration of a closed back view of one embodiment of a self-contained stenciling kit of the present disclosure.

FIG. 6 is an illustration of an open view of one embodiment of a self-contained stenciling kit of the present disclosure.

FIG. 7 is an illustration of a hinged easel portion of one embodiment of a self-contained stenciling kit of the present disclosure. Also shown is a paper storage compartment directly behind the hinged easel portion.

FIG. 8 is an illustration of a pivoting clip component of one embodiment of a self-contained stenciling kit of the present disclosure. Here, the pivoting clip is used for holding paper and a stencil plate.

FIG. 9 is an illustration of a pivoting clip component of one embodiment of a self-contained stenciling kit of the present disclosure. The pivoting clip component is shown with a flared opening. Here, the flared opening of the pivoting clip is useful to allow for easy installation of a stencil plate.

FIG. 10 is an illustration of a lower pocket portion of one embodiment of a self-contained stenciling kit of the present disclosure. Here, the lower pocket is useful to hold and align paper during operation of the kit.

FIG. 11 is an illustration of an easel side rails portion of one embodiment of a self-contained stenciling kit of the present disclosure. Here, the easel side rails are used to align paper and a stencil plate during operation of the kit.

FIG. 12 is an illustration of a hinged pen/pencil holder component of one embodiment of a self-contained stenciling kit of the present disclosure. Also shown is a stencil plate storage compartment directly behind the hinged pen/pencil holder component.

FIG. 13 is an illustration of numbered stencil plates of one embodiment of a self-contained stenciling kit of the present disclosure.

FIG. 14 is an illustration of a pivoting clip component of one embodiment of a self-contained stenciling kit of the present disclosure. Here, the pivoting clip is used for holding paper and a stencil plate.

FIG. 15 is an illustration of a pivoting clip component of one embodiment of a self-contained stenciling kit of the present disclosure. As shown, the pivoting clip component is engaged to hold a stencil plate and paper in place.

FIG. 16 is an illustration of one embodiment of a self-contained stenciling kit of the present disclosure in operation. Here, the coloring process is illustrated, showing a pivoting clip component holding a stencil and paper in place while a subject colors a portion of the stencil plate.

FIG. 17 is an illustration of one embodiment of a self-contained stenciling kit of the present disclosure. As shown, finished piece of artwork is unclipped and ready for removal from the kit. Also shown is the hinged pen/pencil holder component in place on the right side of the opened kit.

### DETAILED DESCRIPTION OF THE INVENTION

The present disclosure relates to, inter alia, a self-contained stenciling kit for producing multicolor and/or unicolor composite images on a target surface. The present disclosure also relates to, inter alia, a method of using the self-contained stenciling kit to produce a multicolor and/or unicolor composite image on a target surface.

In one aspect, the present disclosure provides a self-contained stenciling kit for producing a multicolor and/or unicolor composite image on a target surface. In certain embodiments, the kit includes a foldable case having a front compartment, a rear compartment, and a hinged spine.

In certain embodiments, the front compartment and rear compartment are each pivotally or flexibly mounted adjacent to the hinged spine.

In certain embodiments, the front compartment includes an easel pivotally or flexibly mounted to the bottom of the front compartment and a first storage region behind the easel.

In certain embodiments, the easel includes an alignment pocket and a clip. The alignment pocket is located along the bottom edge of the easel and is used for holding and aligning the target surface and the stencil plate during operation.

As used herein, operation of the kit of the present disclosure refers to the use of the kit and its component parts to apply one or more stencil patterns to the target surface to produce an image, including, without limitation, a multicolor and/or unicolor composite image.

In certain embodiments, the clip is attached at its top edge of the easel for securing the target surface and stencil plate in place during operation.

In certain embodiments, the rear compartment includes a pen/pencil (marking device) holder pivotally or flexibly mounted to the bottom of the rear compartment and a second storage region behind the pen/pencil (marking device) holder. The second storage region is suitable for storing multiple stencil plates or other items, such as embellishments, rules, additional paper, etc.

In certain embodiments, the clip is pivotally attached to the top edge of the easel.

In certain embodiments, the front compartment further includes side rails disposed along either the left side, right side, or both the left and right sides of the front compartment. The side rails are configured to align the target surface and stencil plate in a desired position during operation.

In certain embodiments, the kit further includes a closing mechanism for securing the foldable case in the closed position.

As used herein, the target surface can include, without limitation, a piece of paper, cardstock, or any other surface suitable for applying a stencil pattern thereto.

In another aspect, the present disclosure provides a method of producing a multicolor and/or unicolor composite image on a target surface. This method involves providing a self-contained stenciling kit according to the present disclosure and at least one stencil plate or a collection of stencil plates. During operation, the target surface and a stencil plate are secured at a desired position on the easel using the clip and alignment pocket of the easel. The user then traces, marks, and/or colors the image of the stencil plate to the target surface using any marking, coloring, tracing, or writing device. Once the stencil design is applied to the target surface, the stencil plate is removed from the easel. If desired, the user can then repeat the above steps for a desired number of stencil plates (e.g., from the collection of stencil plates) to produce a multicolor and/or unicolor composite image on the target surface.

In certain embodiments, the tracing, marking, and/or coloring are performed using a pen, pencil, marker, crayon, or any other marking or coloring device.

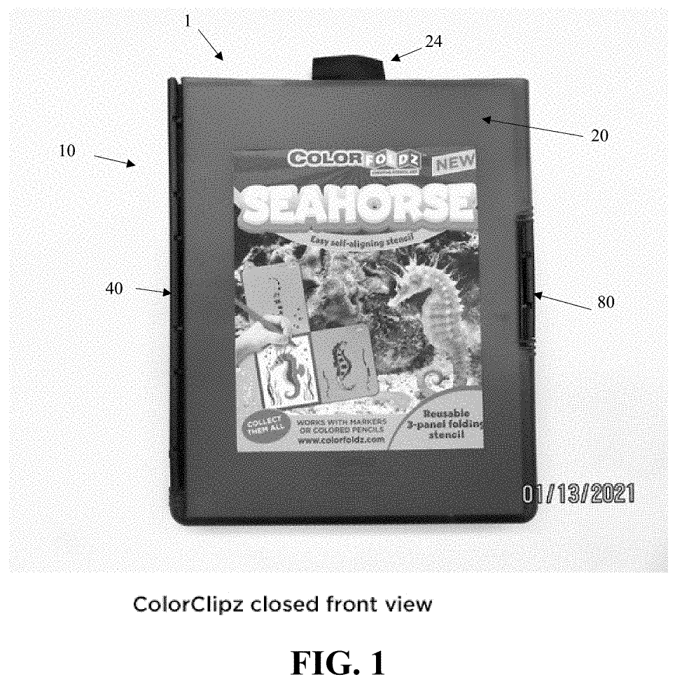

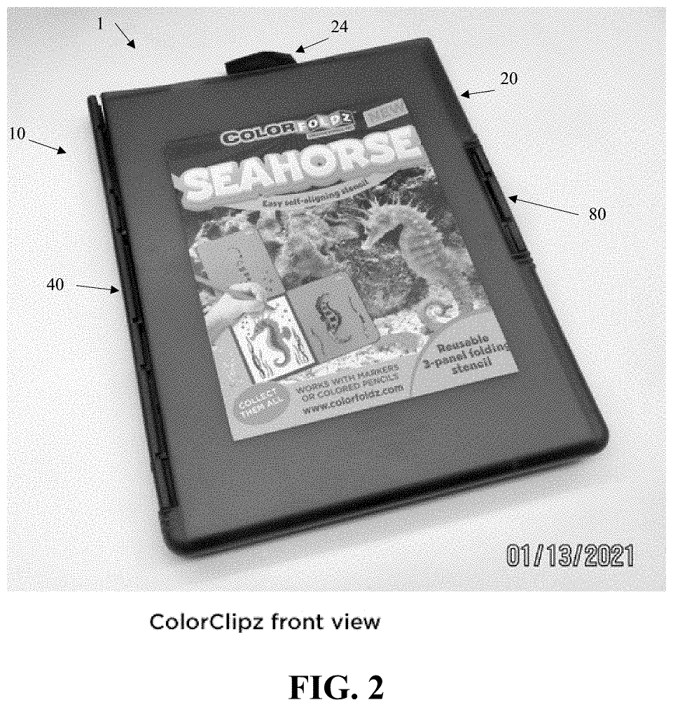

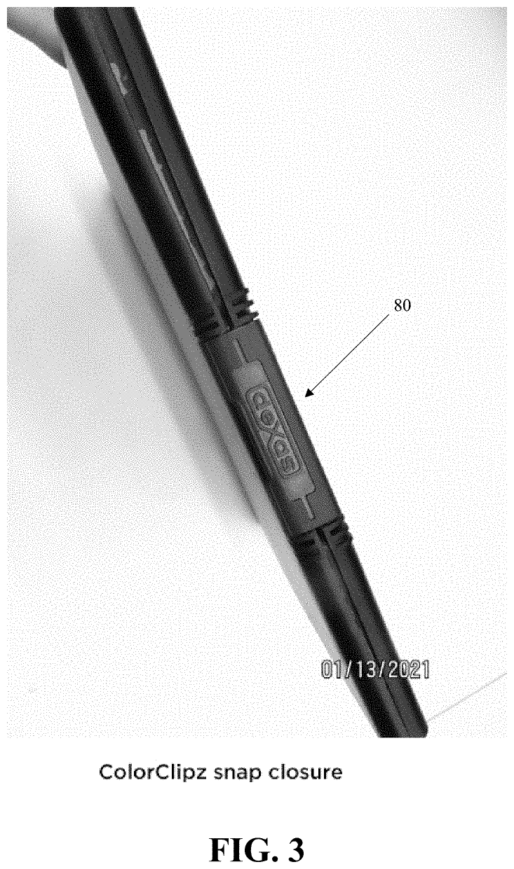

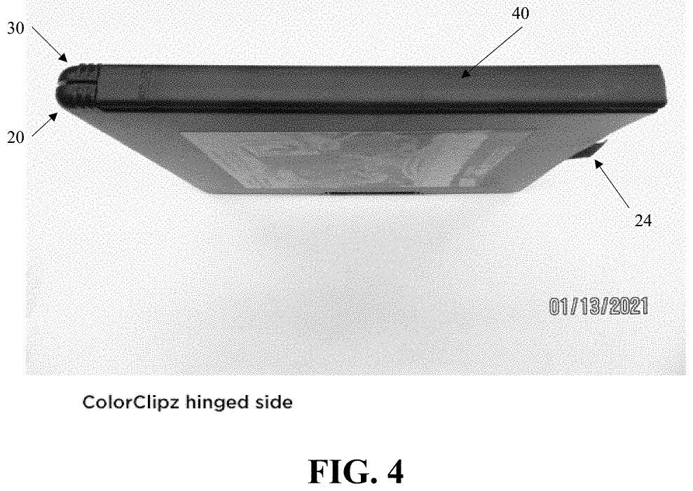

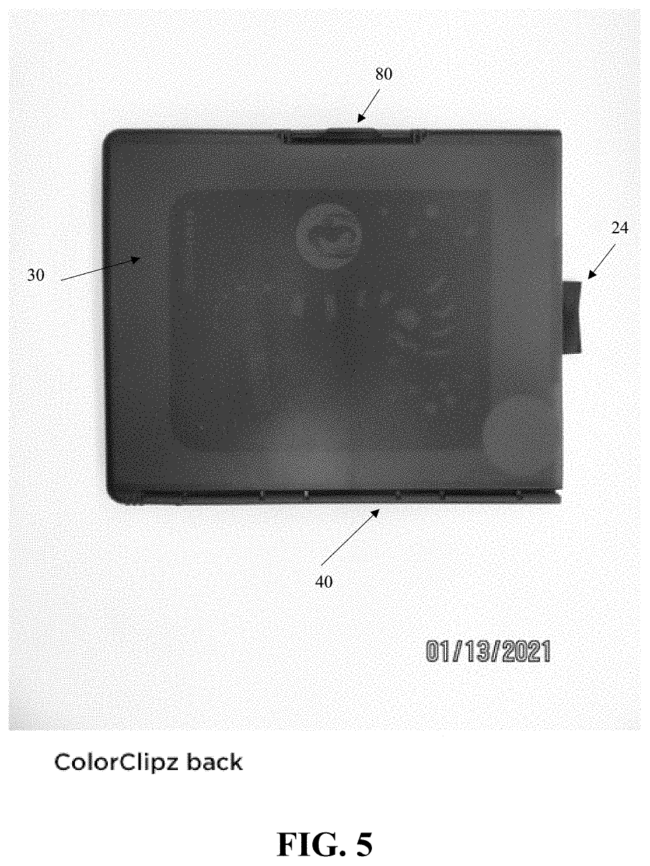

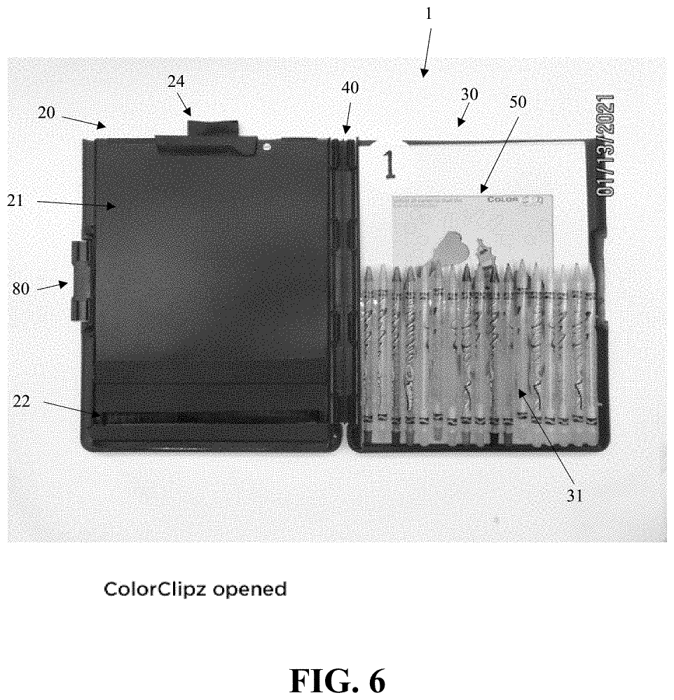

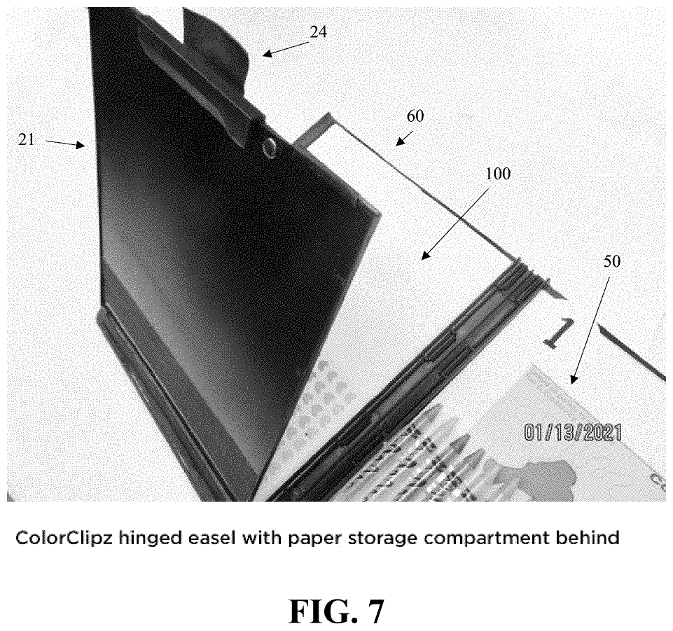

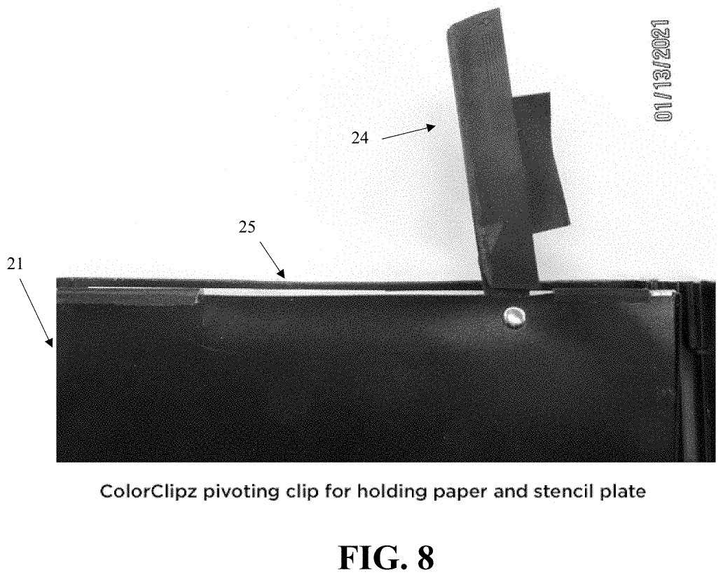

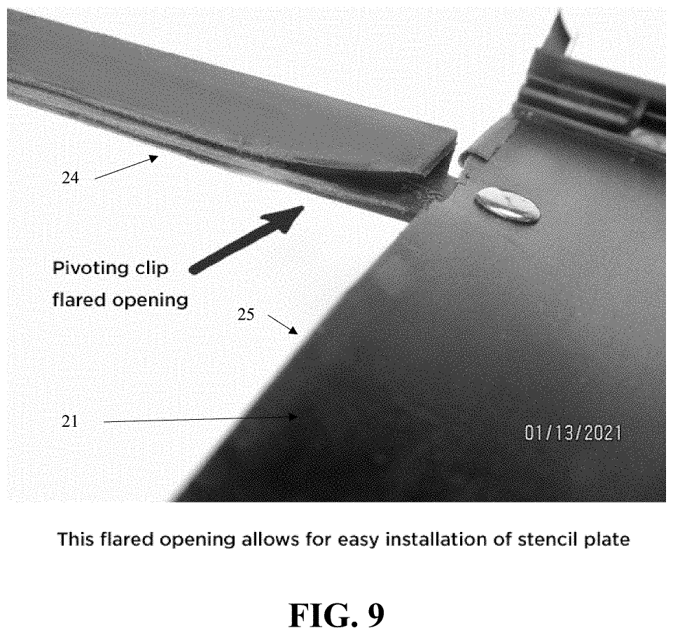

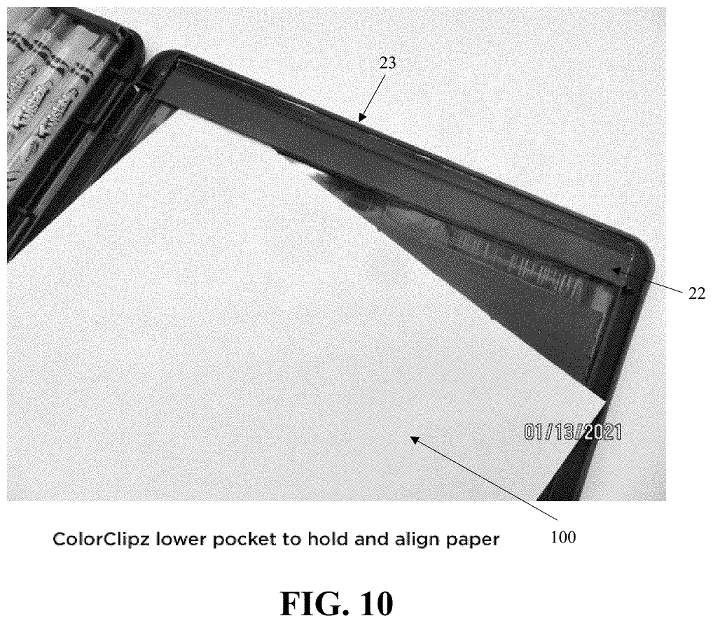

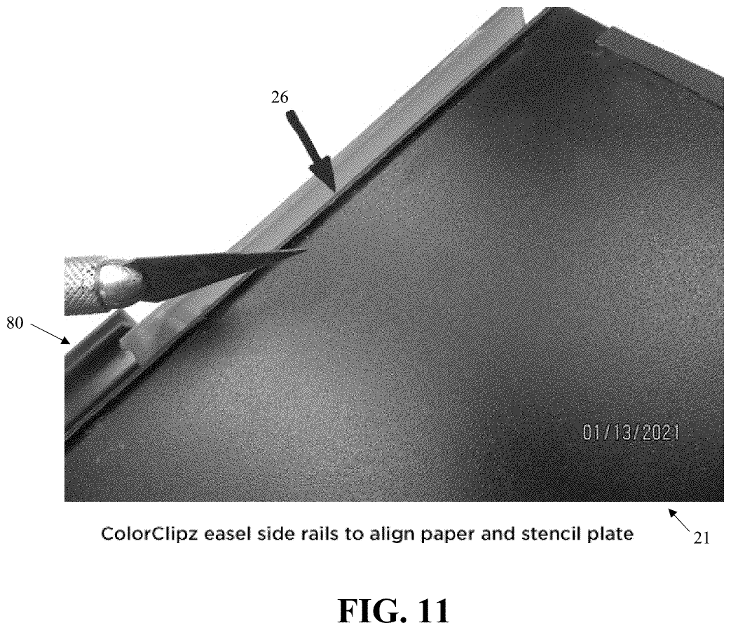

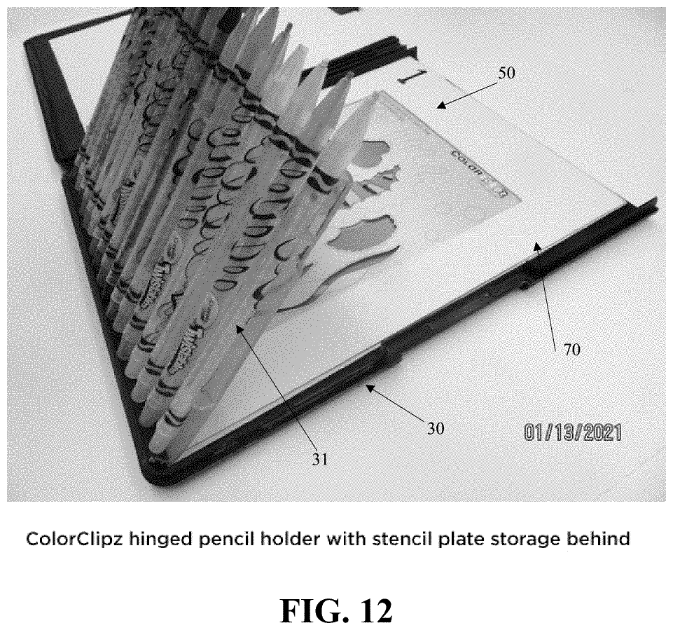

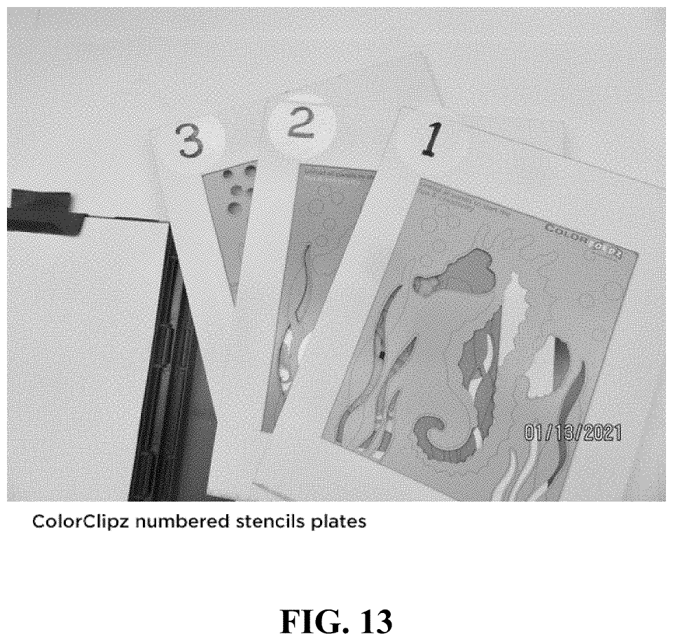

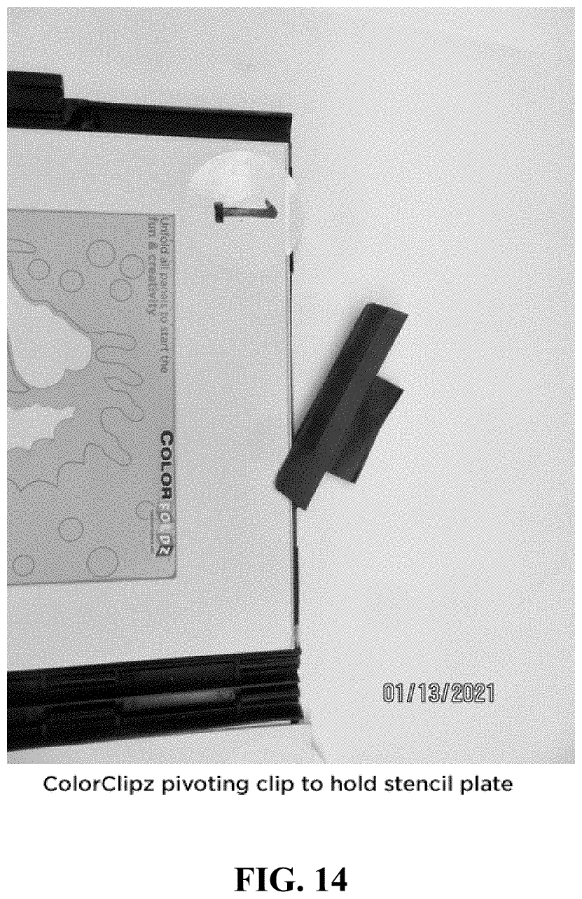

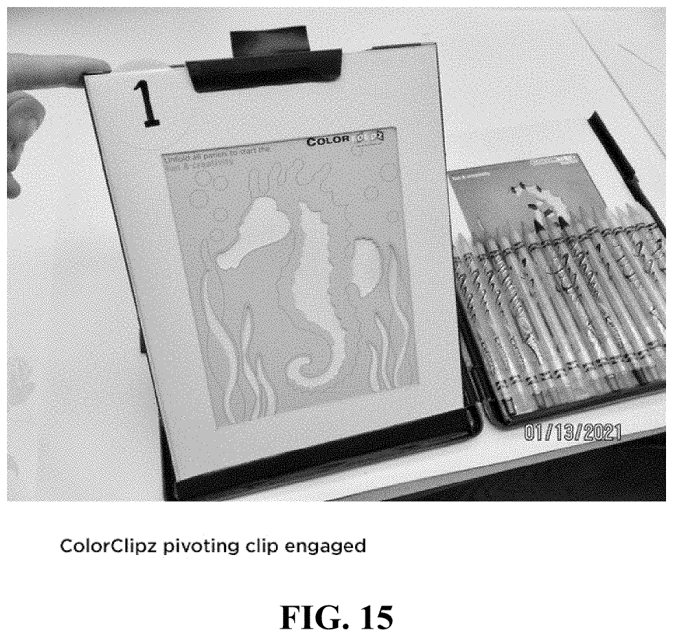

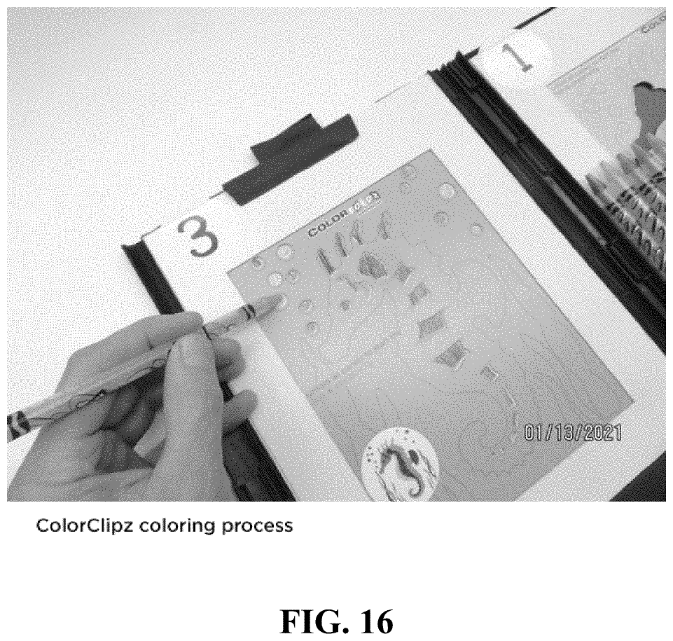

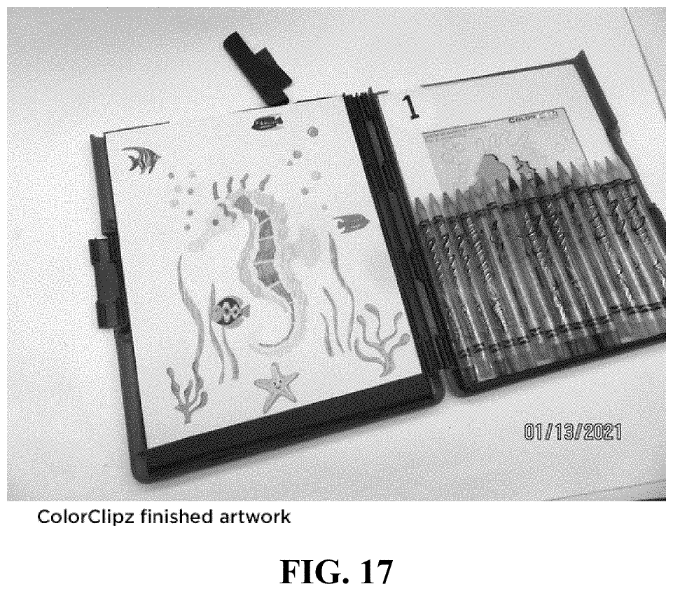

Various aspects and elements of the kit of the present disclosure are shown in FIGS. 1-17.

More specifically, FIGS. 1-12 include reference numerals to identify specific elements of the kit. A key to the reference numerals shown in FIGS. 1-12 is found in Table 1 below.

TABLE 1
Reference Numerals

| Reference No. | Element |
|---|---|
| 1 | Self-Contained Stenciling Kit |
| 10 | Foldable Case |
| 20 | Front Compartment (left compartment when open) |
| 21 | Easel (front, hinged panel of Front Compartment 20) |
| 22 | Alignment Pocket (bottom) |
| 23 | Bottom Edge (of Easel 21) |
| 24 | Clip (of Easel 21) |
| 25 | Top Edge (of Easel 21) |
| 26 | Side Rails (of Easel 21) |
| 26a | Left Side Rails (of Easel 21) |
| 26b | Right Side Rails (of Easel 21) |
| 30 | Rear Compartment (right compartment when open) |
| 31 | Pen/Pencil Holder (front, hinged panel of Rear |
| | Compartment 30) |
| 32 | Bottom Edge (of Pen/Pencil Holder 31) |
| 40 | Hinged Spine (of Foldable Case 10) |
| 50 | Stencil Plate |
| 50a | First Stencil Plate |
| 50b | Second Stencil Plate |
| 50c | Third Stencil Plate |
| 60 | First Storage Region (located in Front Compartment |
| | behind Easel 21) |
| 70 | Second Storage Region (located in Rear Compartment |
| | behind Holder 21) |
| 80 | Closing Mechanism (of Foldable Case 10) |
| 100 | Target Surface (Paper) |

For illustration purposes, reference is made to the FIGS. 1-12 and the reference numerals contained therein to describe one embodiment of a self-contained stenciling kit (1) for producing a multicolor and/or unicolor composite image on a target surface (100). In one embodiment, the kit (1) includes a foldable case (10) having a front compartment (20), a rear compartment (30), and a hinged spine (40). The front compartment (20) and rear compartment (30) are each pivotally or flexibly mounted adjacent to the hinged spine (40). The front compartment (20) includes an easel (21) pivotally or flexibly mounted to the bottom of the front compartment (20) and a first storage region (60) behind the easel (21).

In certain embodiments, the easel (21) includes an alignment pocket (22) and a clip (24). The alignment pocket (22) is located along the bottom edge (23) of the easel (21) and is used for holding and aligning the target surface (100) and the stencil plate (50, 50a, 50b, 50c) during operation.

As used herein, operation of the kit (1) of the present disclosure refers to the use of the kit (1) and its component parts to apply one or more stencil patterns to the target surface (100) to produce an image, including, without limitation, a multicolor and/or unicolor composite image.

In certain embodiments, the clip (24) is attached at its top edge (25) of the easel (21) for securing the target surface (100) and stencil plate (50, 50a, 50b, 50c) in place during operation.

In certain embodiments, the rear compartment (30) includes a pen/pencil (marking device) holder (31) pivotally or flexibly mounted to the bottom of the rear compartment (30) and a second storage region (70) behind the pen/pencil (marking device) holder (31). The second storage region (70) is suitable for storing multiple stencil plates (50, 50a, 50b, 50c) or other items, such as embellishments, rules, additional paper, etc.

In certain embodiments, the clip (24) is pivotally attached to the top edge (25) of the easel (21).

In certain embodiments, the front compartment (20) further includes side rails (26, 26a, 26b) disposed along either the left side, right side, or both the left and right sides of the front compartment (20). The side rails (26, 26a, 26b) are configured to align the target surface (100) and stencil plate (50, 50a, 50b, 50c) in a desired position during operation.

In certain embodiments, the kit (1) further includes a closing mechanism (80) for securing the foldable case (10) in the closed position.

As used herein, the target surface (100) can include, without limitation, a piece of paper, cardstock, or any other surface suitable for applying a stencil pattern thereto.

In another aspect, the present disclosure provides a method of producing a multicolor and/or unicolor composite image on a target surface (100). This method involves providing a self-contained stenciling kit (1) according to the present disclosure and at least one stencil plate (50, 50a, 50b, 50c) or a collection of stencil plates (50, 50a, 50b, 50c). During operation, the target surface (100) and a stencil plate (50, 50a, 50b, 50c) are secured at a desired position on the easel (21) using the clip (24) and alignment pocket (22) of the easel (21). The user then traces, marks, and/or colors the image of the stencil plate (50, 50a, 50b, 50c) to the target surface (100) using any marking, coloring, tracing, or writing device. Once the stencil design is applied to the target surface (100), the stencil plate (50, 50a, 50b, 50c) is removed from the easel (21). If desired, the user can then repeat the above steps for a desired number of stencil plates (50, 50a, 50b, 50c) (e.g., from the collection of stencil plates) to produce a multicolor and/or unicolor composite image on the target surface (100). In certain embodiments, the tracing, marking, and/or coloring are performed using a pen, pencil, marker, crayon, or any other marking or coloring device.

The kit of the present disclosure and the method of using the kit to produce images, including multicolor or unicolor images, is unique in that all components of the kit can be contained in a single foldable case. Any foldable case made of any suitable material is contemplated by the present disclosure, In a particular embodiment, the foldable case is a hard case made of plastic, cardboard, polymer, composites, or any other suitable material that can be used with the component parts of the kit described herein.

In a particular embodiment, the kit opens so that the left and right compartments can be used during operation. One of the compartments will include the hinged easel and related storage region behind the hinged easel, and the opposite compartment will include the hinged pen/pencil holder and related storage region behind the hinged pen/pencil holder. The hinged easel compartment can be on either the left or the right side of the opened foldable case, as long as the opposite side is (whether left or right as the case may be) is the hinged pen/pencil holder compartment. The respective first and second storage areas can include paper, embellishments (e.g., stickers and the like), stencil plates, and any other items that can fit behind the hinged easel (on one side) and the hinged pen/pencil holder (on the other side). The hinged pen/pencil holder can include any writing, marking, or coloring device, including, without limitation, mechanical colored pencils or regular colored pencils, markers, pens, painting devices, and the like. In one embodiment, behind the hinged pen/pencil holder are included stencil plates that can be used to produce the multicolor and/or unicolor composite images.

In reference to FIGS. 1-17, provided below is a further description of the kit of the present disclosure and the operation thereof. Once the user opens the foldable case, he or she can load up the left hinged, easel panel with a piece of paper (or the like). The paper can be stored, for example, behind the left hinged, easel panel. To load the paper, the user would slide the bottom portion of the paper under the built-in ledge (also referred to herein as the alignment pocket) on the bottom of the left hinged, easel panel, and then open the rotating clip attached to the top of the left hinged, easel panel, thereby keeping it open. The user would then take a first stencil plate, which can be stored behind the right hinged, pen/pencil holder panel, and place the first stencil plate over the paper, sliding the bottom portion of the stencil panel under the built-in ledge on the bottom of the left hinged, easel panel, and then rotating the clip in place to secure both the piece of paper and stencil plate in place for coloring the stencil design onto the paper. This mode of operation is effective to hold the stencil on top of the paper, making it a repeatable and precise technique for applying multiple different stencil patterns to the same piece of paper to produce a composite image, which can be multicolor or unicolor or shades of the same or different colors.

To trace and/or color the stencil design for the first stencil plate, the user would take any writing/coloring device (e.g., colored pencils, crayons, etc.), which can be stored in the right hinged, pen/pencil holder panel, or elsewhere. The user may choose any color or colors to use for each stencil plate. Once the tracing/coloring of the first stencil plate is completed, the rotating clip can be disengaged (opened) to allow the user to remove the first stencil plate. The first stencil plate can then be returned to where it was being stored or set aside elsewhere, as the user desires.

In certain embodiments, the different stencil plates can be numbered sequentially (e.g., 1, 2, 3, etc.) so as to provide the user with a suggested order for applying the respective stencil patterns of each stencil plate to the paper.

After the first stencil plate is removed from on top of the paper, the user can take a second stencil plate from a stored location (e.g., the first or second storage regions as described herein), and secure it on top of the paper using the same techniques as used for the first stencil plate. The user can then trace and/or color the pattern of the second stencil plate onto the piece of paper using the same techniques as used for the first stencil plate. This process can be repeated for as many stencil plates as desired by the user, until a completed multicolor or unicolor composite image is drawn/colored onto the piece of paper.

The self-contained stenciling kit of the present disclosure is designed so that each stencil plate is secured in the same, repeatable location on the paper, so as to allow for accurate and precise application of each stencil pattern from each stencil plate onto the single piece of paper.

Once the multicolor or unicolor composite image is complete, the piece of paper and be removed from the front hinged, easel panel (e.g., left panel) and left as is, or further embellished with stickers or any other craft embellishments. The self-contained stenciling kit of the present disclosure can include any such embellishments in one or more storage regions of the kit, including, without limitation, the storage regions behind the left and right front, hinged panels.

The completed multicolored or unicolored composite images can be stored in the kit, or displayed elsewhere. The kit can then be closed up for transporting or for storing until the user or a new user is ready to use the kit.

Any type of drawing or coloring device can be used to apply the stencil patterns to the desired surface (e.g., a piece of paper). Suitable drawing or coloring devices can include, without limitation, mechanical colored pencils, non-mechanical (standard) colored pencils, markers, brushes using paint, black lead or ink, pens.

Although preferred embodiments have been depicted and described in detail herein, it will be apparent to those skilled in the relevant art that various modifications, additions, substitutions, and the like can be made without departing from the spirit of the invention and these are therefore considered to be within the scope of the invention as defined in the claims which follow.

What is claimed is:

1. A self-contained stenciling kit for producing a multicolor and/or unicolor composite image on a target surface, said kit comprising
a foldable case comprising a front compartment, a rear compartment, and a hinged spine, said front compartment and rear compartment each being pivotally or flexibly mounted adjacent to said hinged spine,
wherein said front compartment comprises an easel pivotally or flexibly mounted to the bottom of the front compartment and a first storage region behind the easel,
wherein said easel comprises an alignment pocket and a clip,
said alignment pocket being located along the bottom edge of the easel for holding and aligning the target surface and the stencil plate during operation, and
said clip being attached at its top edge of the easel for securing the target surface and stencil plate in place during operation, and
wherein said rear compartment comprises a pen/pencil (marking device) holder pivotally or flexibly mounted to the bottom of the rear compartment and a second storage region behind the pen/pencil (marking device) holder, said second storage region suitable for storing multiple stencil plates.

2. The kit according to claim 1, wherein the clip is pivotally attached to the top edge of the easel.

3. The kit according to claim 1, wherein said front compartment further comprises side rails disposed along either the left side, right side, or both the left and right sides of the front compartment, said side rails being configured to align the target surface and stencil plate in a desired position during operation.

4. The kit according to claim 1 further comprising a closing mechanism for securing the foldable case in the closed position.

5. The kit according to claim 1, wherein the target surface comprises a piece of paper, cardstock, or any other surface suitable for applying a stencil pattern thereto.

6. A method of producing a multicolor and/or unicolor composite image on a target surface, said method comprising
(a) providing a self-contained stenciling kit according to claim 1 and a collection of stencil plates;
(b) securing a target surface and a stencil plate at a desired position on the easel using the clip and alignment pocket of the easel;
(c) tracing, marking, and/or coloring the image of the stencil plate to the target surface;
(d) removing the stencil plate from the easel; and
(e) optionally repeating steps (b)-(d) for a desired number of stencil plates from the collection of stencil plates to produce the multicolor and/or unicolor composite image on the target surface.

7. The method according to claim 6, wherein the clip is pivotally attached to the top edge of the easel.

8. The method according to claim 6, wherein said front compartment further comprises side rails disposed along either the left side, right side, or both the left and right sides of the front compartment, said side rails being configured to align the target surface and stencil plate in a desired position during operation.

9. The method according to claim 6, wherein said kit further comprises a closing mechanism for securing the foldable case in the closed position.

10. The method according to claim 6, wherein the target surface comprises a piece of paper, cardstock, or any other surface suitable for applying a stencil pattern thereto.

11. The method according to claim 6, wherein the tracing, marking, and/or coloring are performed using a pen, pencil, marker, crayon, or any other marking or coloring device.
